(19) United States
(12) Patent Application Publication
(10) Pub. No.: US 2019/0390942 A1
(43) Pub. Date: Dec. 26, 2019

(54) TARGET SUPPORT

(71) Applicant: Tad Chenoweth, Sheridan, WY (US)

(72) Inventor: Tad Chenoweth, Sheridan, WY (US)

(21) Appl. No.: 16/444,055

(22) Filed: Jun. 18, 2019

Related U.S. Application Data
(60) Provisional application No. 62/688,134, filed on Jun. 21, 2018.

(51) Int. Cl. F41J 7/04; F16M 11/38; F16M 11/10

(52) U.S. Cl. CPC F41J 7/04; F16M 11/10; F16M 11/38

(57) ABSTRACT

A system for supporting targets includes a first frame member having two parallel legs and a link joining the two legs and being substantially perpendicular to both of the two parallel legs. A timing plate is provided to the link so as to project in the general direction of the legs but forming an angle with the legs. A target has a target tongue with a first eyelet on a distal end thereof. Second and third eyelets are provided to the link adjacent to the timing plate and spaced apart a distance sufficient to receive the first eyelet therebetween. A first pin is configured to be received through the first, second and third eyelets, when aligned so as to pivotally secure the target to the link.

### CROSS-REFERENCE TO RELATED APPLICATIONS

This application claims priority to and incorporates by reference in its entirety U.S. Provisional Application No. 62/688,134 filed Jun. 21, 2018 and entitled ‘TARGET SUPPORT SYSTEM’.

### SUMMARY

The disclosure describes a method of supporting targets. The method includes providing a first frame member having two parallel legs and a link joining the two legs and being substantially perpendicular to both of the two parallel legs, the link further including first and second aligned eyelets substantially intermediate the two parallel legs and third and fourth aligned eyelets also substantially intermediate the two parallel legs and providing a timing plate to the link adjacent to the first and second eyelets so as to project in the general direction of the legs but forming an angle therewith. A target is pivotably coupled to the first frame member.

The disclosure further describes a system for supporting targets. The system includes a first frame member having at least two legs joined by a link, a timing plate provided to the link and a target pivotably coupled with the link.

Still further, the disclosure further describes a target support system. The system includes a first frame member having at least two legs spaced apart and joined by a link. A timing plate is provided to the link so as to project in the general direction of the legs while forming an angle therewith. A target having a tongue and is configured for pivotable coupling with the link adjacent a distal end of the tongue. At least one target anchor is provided to the link. A first pin is configured to be received through the at least one target anchor and a portion of the tongue of the target to pivotably couple the target to the link.

### BRIEF DESCRIPTION OF THE FIGURES

The summary above, as well as the following detailed description of illustrative embodiments, is better understood when read in conjunction with the appended drawings. For the purpose of illustrating the disclosed methods and systems, example constructions of the disclosure are shown in the drawings. However, the disclosure is not limited to specific methods and instrumentalities disclosed herein. Moreover, those of ordinary skill in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a front view of an example target support system.

FIG. 2 illustrates a rear view of the example target support system of FIG. 1.

FIG. 3 illustrates a top view of the example target support system of FIGS. 1 & 2.

FIG. 4 illustrates a side view of the example target support system of FIGS. 1-3.

FIG. 5 illustrates a perspective view of the example target support system of FIGS. 1-4.

FIG. 6 illustrates an exploded perspective view of the example target support system of FIGS. 1-5.

FIG. 7 illustrates a rear detail view of example coupling mechanisms suitable for use as part of the example target support system of FIGS. 1-6.

FIG. 8 illustrates a side detail view of the example connection mechanisms of FIG. 7.

### DETAILED DESCRIPTION

The following detailed description illustrates embodiments of the disclosure and manners by which they can be implemented. Although the best mode of carrying out the disclosed systems and methods has been described, those of ordinary skill in the art would recognize that other embodiments for carrying out or practicing disclosed methods are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Embodiments of the disclosure provide a target support system of system for supporting targets that is simple and portable and allows the user to quickly and easily switch from paper targets to steel targets.

A main frame member will support itself by inserting both sides in the ground. A flat backstop material such as plywood, OSB or cardboard can then be inserted on the front between the frame and a series of tabs allowing the user to attach paper targets for the purpose of zeroing handguns, rifles or blackpowder firearms.

An eyelet and pin system facilitates changes between different sizes of steel targets, replacement of steel targets and switching between steel targets and a paper target system. Parts of the support system are individually replaceable and interchangeable so that damaged parts can be replaced without the need to purchase the entire support system. The eyelet and pin system further enables the target support system to fold up when not in use for improved portability.

Additional aspects, advantages, features and objects of the present disclosure will be made apparent from the drawings and the detailed description of the illustrative embodiments construed in conjunction with the appended claims that follow.

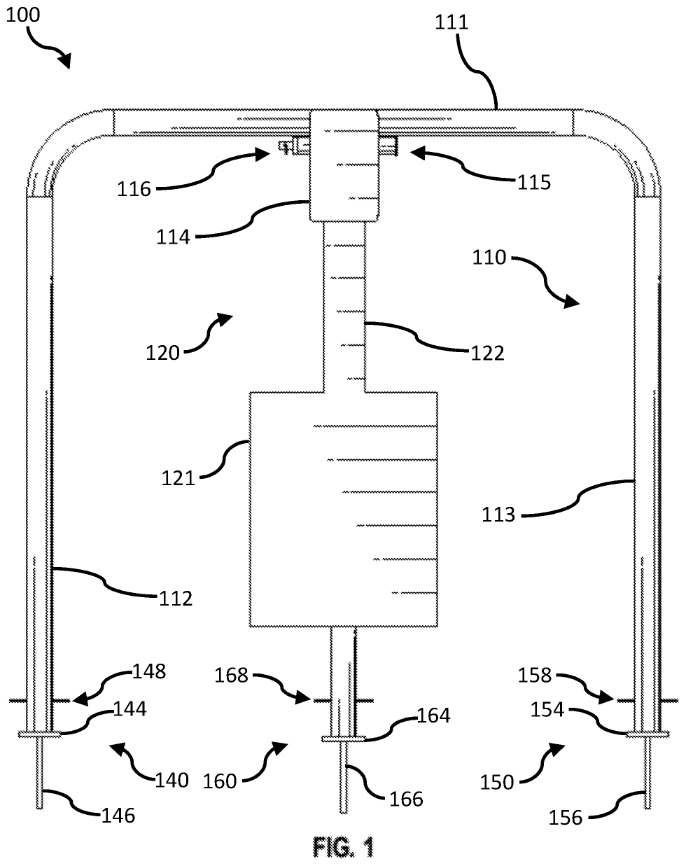

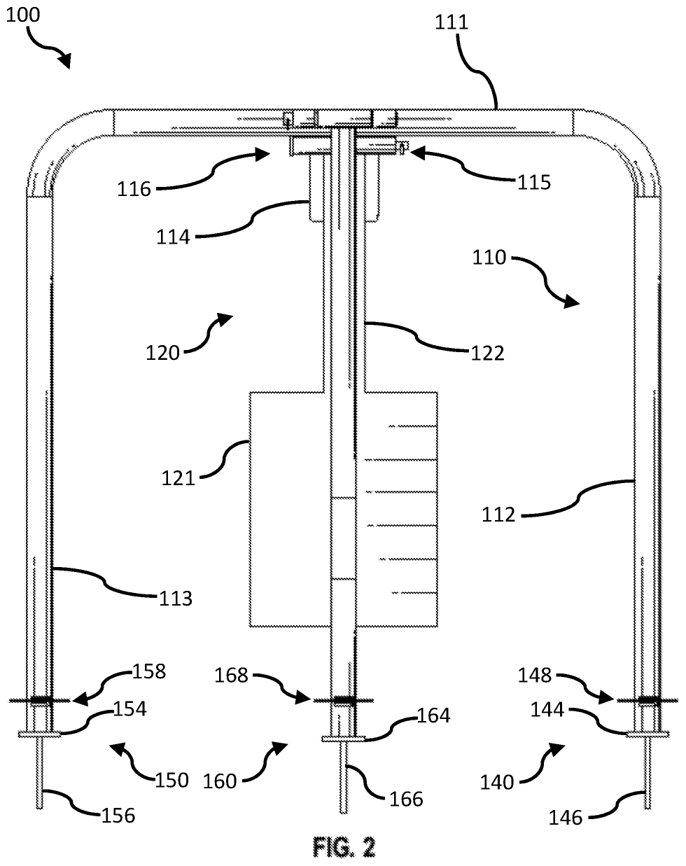

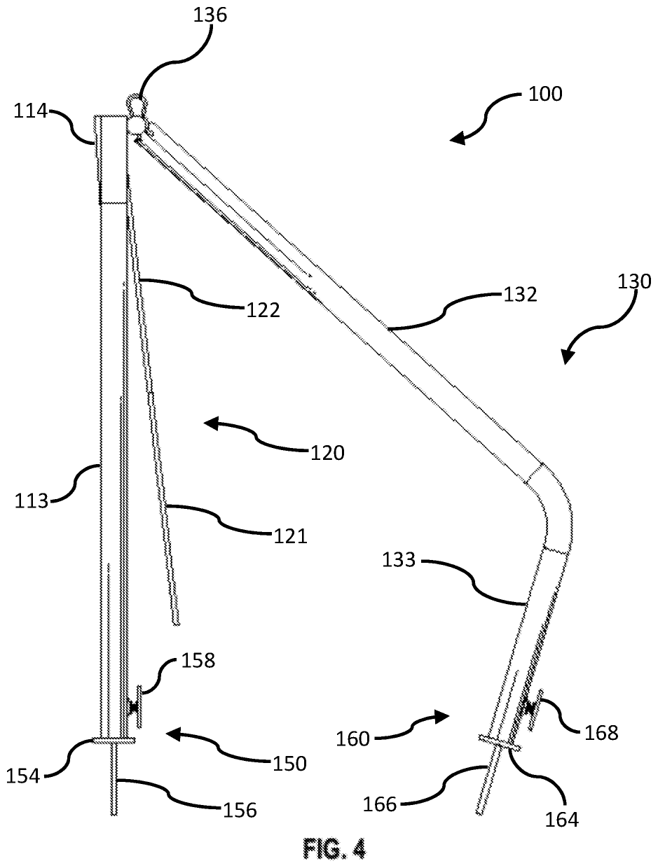

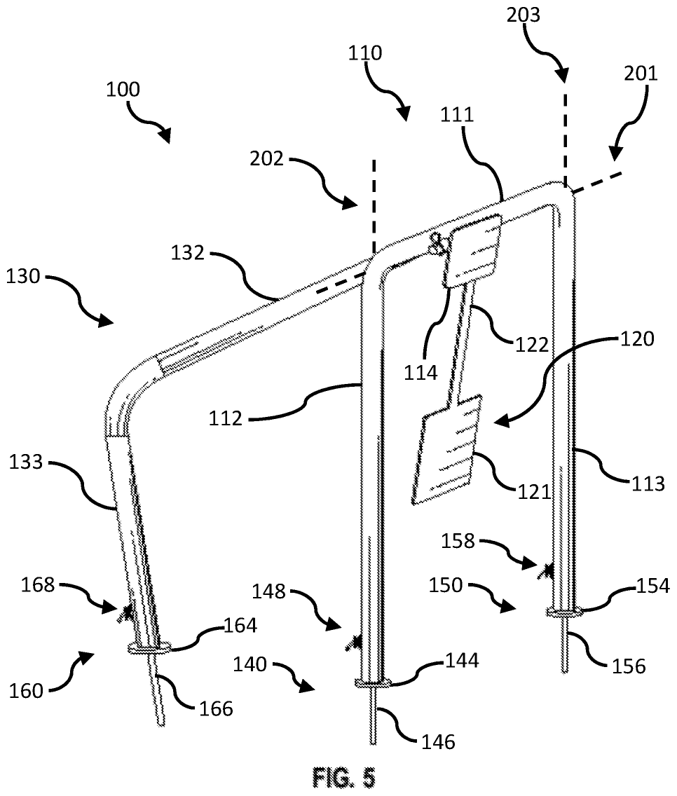

FIGS. 1-8 illustrate a system 100 for supporting targets including a frame member 110 having a link 111 joining and spacing apart two legs 112 and 113. In an example, legs 112 and 113 and link 111 form an inverted ‘U’ shape in which link 111 extends transverse or perpendicular to legs 112 and 113 and centerlines 202, 203 and 201 of legs 112 and 113 and the link 111 lie substantially within a single frontal plane (FIG. 5).

Target support system 100 is large enough to provide a space around a supported steel target to minimize striking by off-placed shots while being small enough to allow for easy transport. While frame member 111 may be provided in any of a variety of corresponding dimensions, in an example, frame member 111 is constructed of 2 cm tubing having any of a variety of cross-sectional shapes such as circular or square. For example, the length of legs 112 and 113 is from about 25 to about 81 cm and the length of link member 111 is about 61 cm. Frame member 110 may be constructed from any of a variety of sturdy, durable materials, including but not limited to wood, steel and composites.

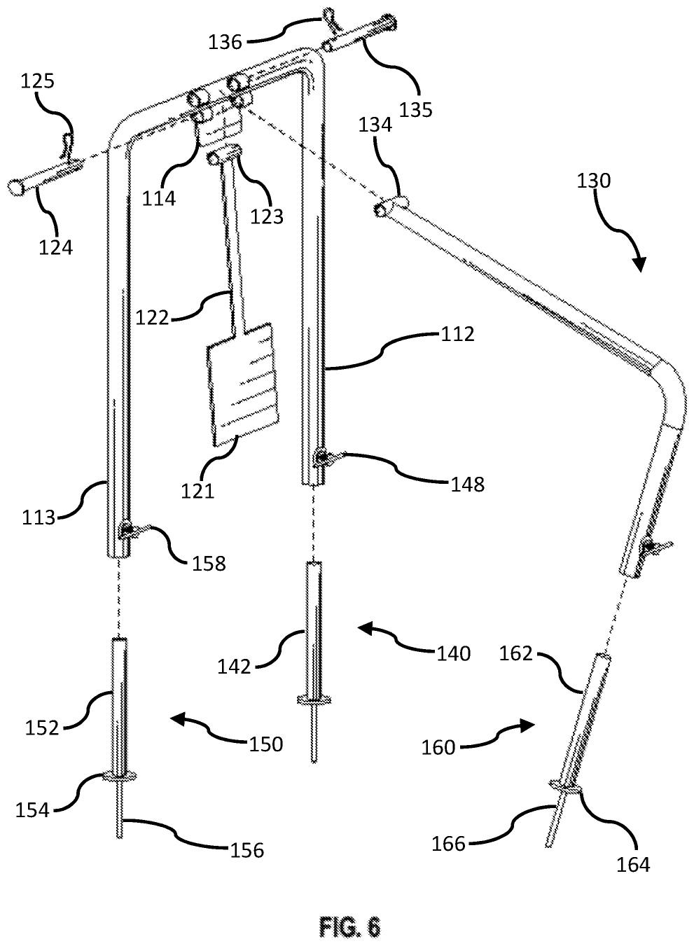

Adjustable feet 140 and 150 may be coupled with legs 112 and 113 so as to extend therefrom at any of a variety of lengths. For example, feet 140 and 150 may be telescopically coupled with legs 112 and 113. In an example, upper portions 142 and 152 of feet 140 and 150 (FIG. 6) are receivable within lumens of legs 112 and 113 and feet 140 and 150 terminate in plates 144 and 154. From plates 144 and 154, stakes 146 and 156 extend into piercing points configured to penetrate the ground to stabilize the target support system 100 in position. While the upper portion of each foot may exhibit any of a variety of dimensions, in an example, the height is about 25 cm while the thickness or diameter is about 2 cm or slightly less than so as to be receivable within the lumen of an associated leg. In an example, stakes 146 and 156 are about 13 cm long and have a thickness of about 1 cm. In a further example, plates 144 and 154 have a diameter of about 5 cm or are about 5 cm wide while having a 0.32 cm thickness.

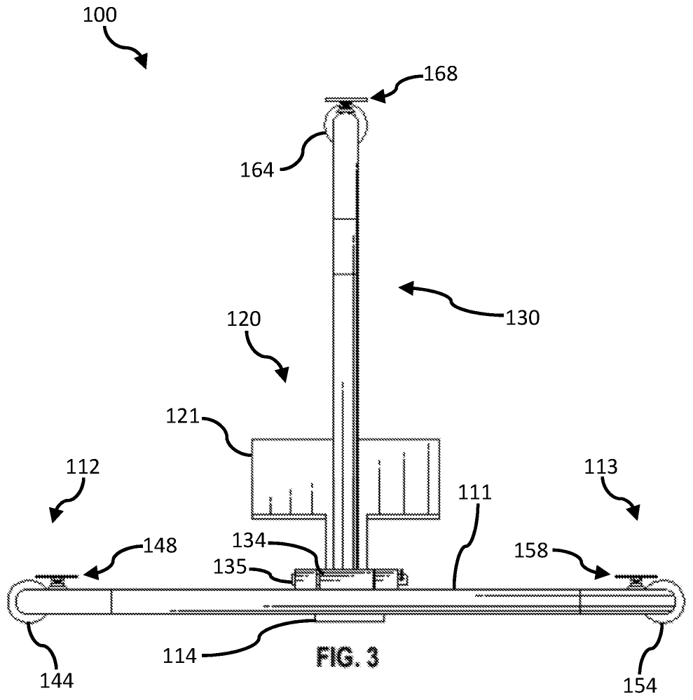

Referring to FIG. 3, system 100 may further include first and second locks 148 and 158 provided to legs 112 and 113 so as to selectively fix the respective feet 140 and 150 at any of the variety of lengths. In an example, locks 148 and 158 each further include a rotatable, threaded member configured to selectively apply pressure to an upper portion 142/152 of the respective foot. Rotating the threaded member in a first direction withdraws an end of the threaded member from contact with the foot 140/150 to allow the foot to be extended from or retracted into the associated leg 112 or 113. Rotating the threaded member in a second direction opposite from the first direction forces the end of the threaded member into contact with the foot 140/150 to prevent the foot from being extended from or retracted into the associated leg 112 or 113. In an example, the threaded member is a 0.95 cm×1.9 cm (0.375 inch×0.75 inch) bolt receivable within a 0.95 cm (0.375 inch) bore into each leg 112/113 directed substantially transverse to the leg length. For increased leverage, a handle in the form of a rod may be provided to the head of the bolt substantially transverse to the bolt's length.

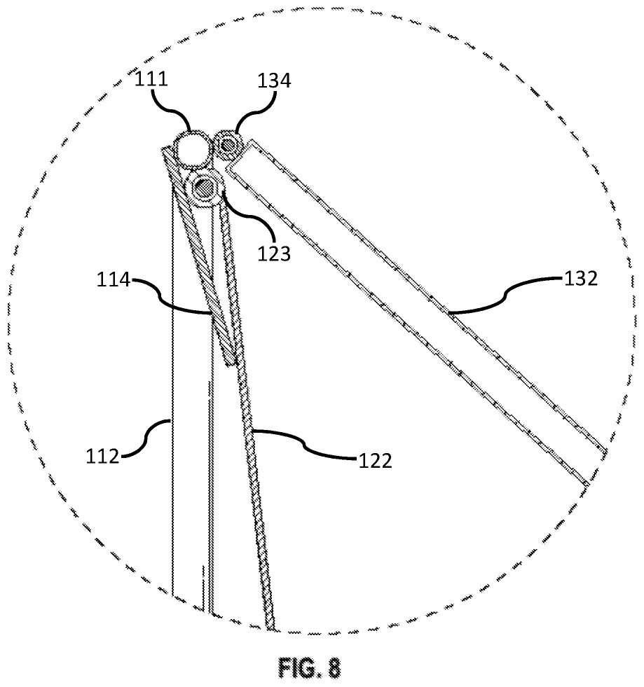

The amount of time it takes steel targets to retime, slow, or reset can be too slow preventing the user from adequate target acquisition if shooting in a timed event or on limited time lines. Referring to FIG. 8, a timing plate 114 is provided to link 111. For example, timing plate 114 may be substantially tangent to an exterior surface of link 111. Timing plate 114 prevents a steel target from swinging forward beyond its starting position and the time it takes steel targets to retime, slow, and/or reset is reduced allowing a user adequate target acquisition while shooting in a timed event or on limited timelines. Timing plate 114 is configured to maintain a target at a minimum angle relative to the frontal plane formed through centerlines 202 and 203 of legs 112 and 113. In an example, timing plate 114 is configured to maintain the target at a minimum angle of from about 15 degrees to about 25 degrees relative to the frontal plane. In a further example, the minimum angle is between about 18 degrees and about 22 degrees. In a more particular example, the minimum angle is about 20 degrees.

Timing plate 111 is provided substantially mid-way between legs 112 and 113 so as to project in the general direction of but form an angle with legs 112 and 113. In an example, timing plate 114 extends at an angle of from about 15 degrees to about 25 degrees relative to the frontal plane formed through centerlines 202 and 203. In a further example, timing plate 114 extends at an angle of from about 18 degrees to about 22 degrees relative to the frontal plane. In a more particular example, timing plate 114 extends at an angle of about 20 degrees relative to the frontal plane.

While timing plate 114 may take any of a variety of dimensions depending on the reset duration desired, in an example, the timing plate has a height of about 10 cm, a width of about 8 cm and a thickness of about 0.6 cm. To decrease the reset duration the height may be increased and to increase the reset duration, the height may be decreased. Decreasing the reset duration may also be accomplished with a larger angle between timing plate 114 and the frontal plane of frame member 110. In contrast, increasing the reset duration may be accomplished with a smaller angle between timing plate 114 and the frontal plane of frame member 110.

It should be observed that the angle timing plate 114 forms with the frontal plane of frame member 110 will generally be greater than the angle formed between a coupled target and the frontal plane due to the smaller dimensions of timing plate 114.

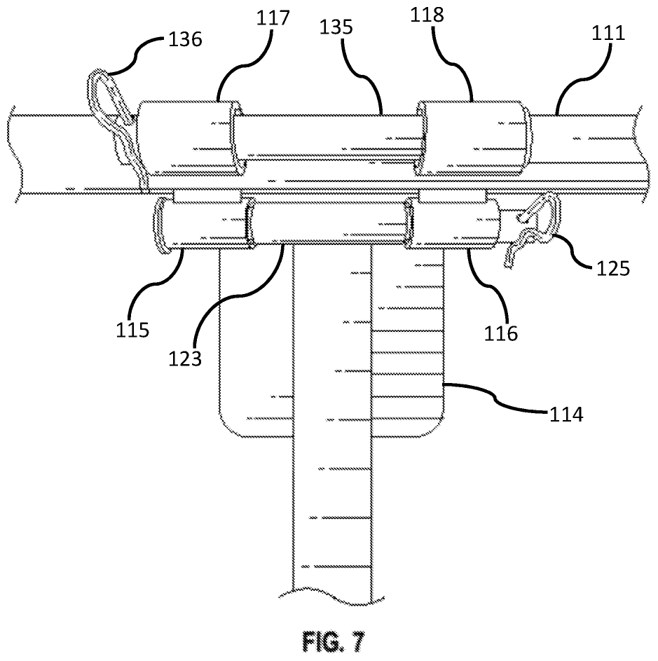

Referring to FIG. 6, a target 120 has a target tongue 122 with a distal end and an eyelet 123 on or adjacent to the distal end. A target anchor is provided to link 111 for pivotable coupling of target 120 by eyelet 123 of target tongue 122. The target anchor may be provided as a first set of aligned eyelets 115 and 116 (FIG. 7) substantially intermediate legs 112 and 113, adjacent to timing plate 114 and spaced apart a distance sufficient to receive eyelet 123 of target tongue 122 therebetween. In an example, target tongue 122 measures about 23 cm long by about 5 cm wide.

A first hinge pin 124 is configured for receipt through eyelet 123 of target tongue 122 and the target anchor, when aligned. A retaining clip 125 is configured to resist removal of first hinge pin 124 from the target anchor. In an example, retaining clip 125 takes the form of a cotter pin. Target 120 is pivotably coupled with frame member 110 so as to pivot about an axis substantially parallel with link 111 and transverse to legs 112 and 113. Correspondingly, the pivot axis of target 120 may also be regarded as substantially perpendicular to legs 112 and 113.

weight of a steel target allows only limited motion yet also allows for distribution of impact energy. Timing plate 114 maintains target 120 in an orientation angled back from vertical such that bullet impact fragmentation is directed towards the ground.

Referring to FIGS. 3 & 4, a third leg 130 may be provided with upper 132 and lower 133 portions meeting at an angle. In an example, upper 132 and lower 133 portions of third leg 130 may be provided as first and second separable pieces for easier packaging and shipping.

Third leg 130 may be pivotably coupled with first frame 110 so as to pivot about an axis substantially parallel with link 111 and substantially perpendicular or transverse to legs 112 and 113. Upper portion 132 includes a distal end with an eyelet 134 provided thereto. Another anchor in the form of a second set of eyelets 117 and 118 (FIG. 7) may be provided to link 111 of frame member 110 spaced apart a distance sufficient to receive therebetween eyelet 134 of upper portion 132. Eyelets 117 and 118 may be spaced apart from eyelets 115 and 116 around the exterior of link 111. In an example, when viewed from the side, eyelets 117 and 118 may be spaced from eyelets 115 and 116 by an arc of between about 30 degrees to about 90 degrees. In a further example, eyelets 115 and 116 are provided to bottom portion of the exterior of link 111 while eyelets 117 and 118 are provided to a rear portion of the exterior of link 111.

A hinge pin 135 configured to be received through eyelets 117 and 118 when the eyelets are aligned with eyelet 134 pivotally secures third leg 130 to link 111 allowing for adjustment of the angle between third leg 130 and frame member 110. A retaining clip 136 or cotter pin inserted through a bore in hinge pin 135 holds pin 135 in place inserted through eyelets 117, 118 and 134.

Third leg 130 may also be provided with a foot 160 telescopically coupled therewith so as to extend at any of a variety of lengths. Foot 160 may take a form similar to that described above with respect to feet 140 and 150. As with feet 140 and 150, a lock 168 may be provided to third leg 130 so as to selectively fix third foot 160 at any of a variety of lengths. In an example, third lock 168 further includes a rotatable, threaded member configured to selectively apply pressure to upper portion 162 of third foot 160. Rotating the threaded member in a first direction allows foot 160 to be extended from or retracted into the associated leg 130 while rotating the threaded member in a second direction opposite from the first direction prevents foot 160 from being extended from or retracted into the associated leg 130. For increased leverage, a handle in the form of a rod may be provided to the head of the bolt substantially transverse to the bolt's length. Lock dimensions may be similar to those described above with respect to locks 148 and 158.

With third leg 130 installed, timing plate 114 is configured to maintain target 120 at an angle towards third leg 130. With centerlines of link 111 and legs 112 and 113 extending within a substantially vertical plane, third leg 130 and timing plate 114 extend at an angle behind the substantially vertical plane.

A method of supporting targets includes providing a first frame member 110 having two legs 112 and 113 and a transverse link 111 joining the legs. The link 111 further includes a first set of eyelets 115 and 116 substantially intermediate the legs 112 and 113 as well as a second set of eyelets 117 and 118 also substantially intermediate the legs 112 and 113. A timing plate 114 is provided to the link 111 adjacent to the first set of eyelets 115, 116, 117 and 118 so as to project in the general direction of legs 112 and 113 but forming an angle therewith.

The method may further include sliding a first foot 140 so as to extend a selected distance from the first leg 112 and fixing the extended foot at the selected distance with a first lock 168. The method may further include sliding a second foot 150 so as to extend a selected distance from the second leg 113 and fixing the extended foot at the selected distance with a second lock 158. Fixing the extended feet with locks may further include rotating threaded members to apply pressure to a portion of the respective feet 140 and 150. With feet 140 and 150 at the desired length and first frame member 110 in a substantially vertical orientation, stakes 146 and 156 can be pushed or driven into a support surface such as an area of ground so that frame member 110 is maintained generally upright.

A target 120 is pivotally coupled with the first frame member 110 by inserting a hinge pin 124 through the first set of eyelets 115 and 116 and an eyelet 123 on a distal end of a target tongue 122 of the target 120. With hinge pin 124 received through eyelets 115, 116 and 123, a retaining pin 125 may be provided through hinge pin 124 so as to prevent hinge pin 124 from sliding out of eyelets 115, 116 and 123 during use of system 100.

Optionally, a third leg 130 having upper 132 and lower 133 portions meeting at an angle may be pivotally coupled with link member 111 by inserting a pin 135 through the second set of eyelets 117 and 118 and an eyelet 134 provided at a distal end of upper portion 132. With hinge pin 135 received through eyelets 117, 118 and 134, a retaining pin 136 may be provided through hinge pin 135 so as to prevent hinge pin 135 from sliding out of eyelets 117, 118 and 134 during use of system 100. Further, a third foot 160 may be slid so as to extend a selected distance from third leg 130 and fixed at the selected distance with a third lock 168 through rotation of a threaded member. Stake 166 may be pushed or driven into an area of ground to reinforce the upright position of frame member 110 and system 100.

In some circumstances, it may be preferred to couple third leg 130 to link member 111 before the coupling of target 120. For example, if the area of ground upon which system 100 is supported is too hard to accept either of stakes 146 and 156, it may be necessary to provide third leg 130 so as to stabilize system 100 before coupling target 120. In other examples, attachment of third leg 130 may be unnecessary.

A projectile propelled at system 100 will pass through a frontal plane defined through centerlines of link 111 and legs 112 and 113 before striking target 120. The target 120 is configured to pivot backwards and away from timing plate 114 upon being impacted by a projectile propelled at the system. With third leg 130 installed, target 120 is configured to pivot towards third leg 130 upon impact. After pivoting backwards, target 120 will pivot forward under its own weight until coming to rest against timing plate 114 as before being struck with a projectile.

Setting up a target on uneven ground such as on hillsides can make it difficult to properly secure a target. If it is determined a different height is preferred for target 120 and/or system 100, the first, second and third feet may be adjusted such that more or less extend from the first, second and third legs. Further, if the area of ground upon which system 100 is to be supported is not level, it may be preferred to adjust the extension of one or more of the feet such that one or more feet extend further from the legs than the remaining feet to compensate for the angle of the area of ground.

If the user desires to replace a steel target, change between different sizes of steel targets or switch between steel targets and a paper target system, pin 124 is removed from the eyelets 115, 116 and 123, and target 120 is separated from frame member 110. When retaining clip 125 has been used to secure hinge pin 124 it will require removal before complete removal of hinge pin 124. With target 120 separated from frame member 110, a replacement target or target of a different size may be pivotably coupled with frame member 110 through use of eyelets 115, 116, an eyelet of the different target and hinge pin 124.

Alternatively, with target 120 removed, a flat backstop material such as plywood, OSB or cardboard can then be inserted on the front between the frame and a series of tabs for use of paper targets.

After use, for storage or transportation, target support system 100 may be collapsed and/or disassembled. After loosening locks 148, 158 and 168, upper portions 142, 152 and 162 may be retracted into the respective legs 112, 113 and 130 at least up to plate portions 144, 154 and 164. With upper portions 142, 152 and 162 retracted, locks 148, 158 and 168 may be tightened again to hold feet 140, 150 and 160. Alternatively, feet 140, 150 and 160 may be completely removed from legs 112, 113 and 130.

As described in part above, by removing pin 124 from the eyelets 115, 116 and 123, target 120 may be separated from frame member 110 and by removing pin 135 from the second set of eyelets 117, 118 and 134, third leg 130 may also be separated from frame member 110. When retaining clips 125 and 136 have been used to secure hinge pins 124 and 135, the retaining clips will require removal before complete removal of hinge pins 124 and 135 is possible. With system 100 completely disassembled, components thereof can be laid nearly completely flat and roughly fit within the outer dimensions of frame member 110.

It will be appreciated that features of the present disclosure are susceptible to being combined in various combinations without departing from the scope of the present disclosure as defined by the appended claims. In an alternative, a target support system may be provided for use of steel targets which hang by chains, cable or rope.

Modifications to disclosed embodiments are possible without departing from the scope of the disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A method of supporting targets, comprising:
providing a first frame member having two parallel legs and a link joining the two parallel legs and being substantially perpendicular thereto, the link further including first and second aligned eyelets substantially intermediate the two parallel legs and third and fourth aligned eyelets also substantially intermediate the two parallel legs;
providing a timing plate to the link adjacent to the first and second eyelets so as to project in the general direction of the legs but forming an angle therewith; and
pivotally coupling a target to the first frame member.

2. The method as set forth in claim 1, wherein pivotally coupling the target to the first frame member further comprises inserting a pin through the first and second eyelets and a fifth eyelet on a distal end of a target tongue of the target.

3. The method as set forth in claim 1, further comprising limiting pivoting of the target with the timing plate.

4. The method as set forth in claim 1, further comprising, to the first frame member, pivotally coupling a third leg having upper and lower portions meeting at an angle and a sixth eyelet provided at a distal end of the upper portion.

5. The method as set forth in claim 5, wherein pivotally coupling the third leg further comprises inserting a pin through the third, fourth and sixth eyelets.

6. The method as set forth in claim 1, further comprising, in response to pivoting of the target by a projectile, arresting pivoting of the target with the timing plate.

7. A system for supporting targets, comprising:
a first frame member having at least two legs joined by a link;
a timing plate provided to the link; and
a target pivotably coupled with the link.

8. The system as set forth in claim 7, wherein the timing plate is provided so as to extend substantially at an angle to a frontal plane formed through centerlines of the at least two legs.

9. The system as set forth in claim 7, wherein the timing plate is provided so as to extend at an angle of from about 15 degrees to about 25 degrees relative to a frontal plane formed through centerlines of the at least two legs.

10. The system as set forth in claim 7, wherein the timing plate is provided so as to extend at an angle of about 20 degrees relative to a frontal plane formed through centerlines of the at least two legs.

11. The system as set forth in claim 7, wherein the target is configured to pivot away from the timing plate upon being impacted by a projectile propelled at the system.

12. The system as set forth in claim 7, further comprising a third leg pivotably coupled with the first frame member.

13. The system as set forth in claim 12, wherein with centerlines of the link and the at least two legs extending within a substantially vertical plane, the third leg and the timing plate extend at an angle behind the substantially vertical plane.

14. The system as set forth in claim 12, wherein a projectile propelled at the system will pass through a frontal plane defined through centerlines of the link and the at least two legs before striking the target.

15. The system as set forth in claim 12, wherein the target is configured to pivot towards the third leg upon being impacted by a projectile propelled at the system.

16. The system as set forth in claim 7, further comprising:
a target tongue provided to the target and including a first eyelet on a distal end;
second and third eyelets provided to the link adjacent to the timing plate and spaced apart a distance sufficient to receive the first eyelet therebetween; and
wherein the target is pivotally coupled with the link by a first pin received through the first, second and third eyelets.

17. A target support system, comprising:
a first frame member having at least two legs spaced apart and joined by a link;
a timing plate provided to the link so as to project in the general direction of the legs while forming an angle therewith;
a target having a tongue and configured for pivotable coupling with the link adjacent a distal end of the tongue;
at least one target anchor provided to the link; and
a first pin configured to be received through the at least one target anchor and a portion of the tongue of the target to pivotably couple the target to the link.

18. The system as set forth in claim 17, wherein the timing plate is configured to maintain the target at a minimum angle relative to a frontal plane formed through centerlines of the at least two legs.

19. The system as set forth in claim 18, wherein the minimum angle is between about 18 degrees and about 22 degrees.

20. The system as set forth in claim 18, wherein the minimum angle is about 20 degrees.
